(19) United States
(12) Patent Application Publication
(10) Pub. No.: US 2018/0176278 A1
(43) Pub. Date: Jun. 21, 2018

(54) DETECTING AND SIGNALING NEW INITIALIZATION SEGMENTS DURING MANIFEST-FILE-FREE MEDIA STREAMING

(71) Applicant: QUALCOMM Incorporated, San Diego, CA (US)

(72) Inventors: Giridhar Dhati Mandyam, San Diego, CA (US); Gordon Kent Walker, Poway, CA (US); Thomas Stockhammer, Bergen (DE); Charles Nung Lo, San Diego, CA (US); Waqar Zia, Munich (DE)

(21) Appl. No.: 15/842,340

(22) Filed: Dec. 14, 2017

Related U.S. Application Data
(60) Provisional application No. 62/436,196, filed on Dec. 19, 2016.

(51) Int. Cl. H04L 29/06

(52) U.S. Cl. CPC H04L 65/605; H04L 65/608; H04L 65/607

(57) ABSTRACT

An example device for retrieving media data includes a middleware unit configured to receive a first initialization segment of a broadcast stream of media data, receive a second initialization segment of the broadcast stream of media data, and determine whether initialization information of the second initialization segment is different than initialization information of the first initialization segment. When the second initialization segment includes different initialization information, the middleware unit sends an indication to a media application that media playback is to be reinitialized using the initialization information of the second initialization segment. Otherwise, if the initialization information is the same, the middleware unit sends media data of the broadcast stream received following the second initialization segment to the media application without sending the indication to the media application that the media playback is to be reinitialized.

This application claims the benefit of U.S. Provisional Application No. 62/436,196, filed Dec. 19, 2016, the entire contents of which are hereby incorporated by reference.

### TECHNICAL FIELD

This disclosure relates to storage and transport of encoded media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this application describes techniques for handling channel change events in a streaming environment. In particular, media data may be delivered to a proxy server using a file transform format, such as Real-Time Object Delivery over Unidirectional Transport (ROUTE). A client device may include a streaming client, such as a Dynamic Adaptive Streaming over HTTP (DASH) client, that receives media data from the proxy server. The streaming client and the proxy server may establish a WebSocket session by negotiating a WebSocket subprotocol. In accordance with the techniques of this disclosure, the proxy server (of a middleware unit) may detect new initialization segments, that is, that a received initialization segment includes new initialization information. In response to detecting a new initialization segment, the middleware unit may signal to a media application (e.g., a DASH client) that new initialization information has been received, to cause the media application to reinitialize media playback.

In one example, a method of retrieving media data includes, by a middleware unit of a client device including a media application, receiving a first initialization segment of a broadcast stream of media data, receiving a second initialization segment of the broadcast stream of media data, determining whether initialization information of the second initialization segment is different than initialization information of the first initialization segment, and in response to determining that the initialization information of the second initialization segment is different than the initialization information of the first initialization segment, sending an indication to the media application that media playback is to be reinitialized using the initialization information of the second initialization segment.

In another example, a method of retrieving media data includes, by a middleware unit of a client device including a media application, receiving a second initialization segment of the broadcast stream of media data, determining whether initialization information of the second initialization segment is different than initialization information of the first initialization segment, and in response to determining that the initialization information of the second initialization segment is the same as the initialization information of the first initialization segment, sending media data of the broadcast stream received following the second initialization segment to the media application without sending an indication to the media application that the media playback is to be reinitialized.

In another example, a device for retrieving media data includes a memory configured to store media data, and a middleware unit comprising one or more processors implemented in circuitry. The middleware unit is configured to receive a first initialization segment of a broadcast stream of media data, receive a second initialization segment of the broadcast stream of media data. determine whether initialization information of the second initialization segment is different than initialization information of the first initialization segment, in response to determining that the initialization information of the second initialization segment is different than the initialization information of the first initialization segment, send an indication to a media application that media playback is to be reinitialized using the initialization information of the second initialization segment, and in response to determining that the initialization information of the second initialization segment is the same as the initialization information of the first initialization segment, send media data of the broadcast stream received following the second initialization segment to the media application without sending the indication to the media application that the media playback is to be reinitialized.

In another example, a device for retrieving media data includes means for receiving a first initialization segment of a broadcast stream of media data, means for receiving a second initialization segment of the broadcast stream of media data, means for determining whether initialization information of the second initialization segment is different than initialization information of the first initialization segment, means for sending, in response to determining that the initialization information of the second initialization segment is different than the initialization information of the first initialization segment, an indication to a media application that media playback is to be reinitialized using the initialization information of the second initialization segment, and means for sending, in response to determining that the initialization information of the second initialization segment is the same as the initialization information of the first initialization segment, media data of the broadcast stream received following the second initialization segment to the media application without sending the indication to the media application that the media playback is to be reinitialized.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of a retrieval unit.

FIG. 3 is a conceptual diagram illustrating elements of example multimedia content.

FIG. 4 is a block diagram illustrating elements of an example video file.

FIG. 5 is a block diagram illustrating an example system that may perform the techniques of this disclosure.

FIG. 6 is a flow diagram illustrating an example communication exchange between components of a system.

FIG. 7 is a conceptual diagram illustrating an example set of media content.

FIG. 8 is a conceptual diagram illustrating an example set of initialization segments that may be received during media streaming.

FIG. 9 is a conceptual diagram illustrating another example technique for determining whether a new IS has been received (and thus, detecting a period boundary).

FIG. 10 is a block diagram illustrating the ROUTE handler and the DASH client of FIG. 5 participating in a WebSocket connection.

FIG. 11 is a flowchart illustrating an example method of receiving media data according to the techniques of this disclosure.

### DETAILED DESCRIPTION

In general, this disclosure describes techniques for transferring media data, e.g., using a WebSocket protocol from a proxy server of a middleware unit of a client device to a media application of the client device. The proxy server may receive media data via a broadcast, such as an over-the-air (OTA) broadcast or a network broadcast using multimedia broadcast/multicast service (MBMS) or enhanced MBMS (eMBMS).

Alternatively, the proxy server may obtain the media data from a separate device, such as a channel tuner device, that receives the media data via a broadcast. The proxy server may be configured to act as a server device with respect to the streaming client. The streaming client may be configured to use network streaming techniques, such as Dynamic Adaptive Streaming over HTTP (DASH), to retrieve media data from the proxy server and to present the media data.

A user may interact with a channel tuner (that is, a channel selection device) when observing media data (e.g., listening to audio and/or watching video). Furthermore, the user may interact with the channel tuner to change a currently tuned channel. For example, if the user is currently watching a program on one channel, the user may switch to a new channel to watch a different program. In response, the channel tuner may switch to the new channel and begin receiving media data of the new channel. Likewise, the channel tuner may provide media data of the new channel to the proxy server.

As part of a streaming service, such as DASH, a streaming client (e.g., a DASH client) typically uses a manifest file, such as a media presentation description (MPD) to retrieve media data from a server device. Thus, a conventional streaming client would await delivery of the manifest file before being able to retrieve media data of a new channel following a channel change event. However, awaiting the manifest file can delay the time between the channel change event and the time at which the user is able to observe media data of the new channel, even if playable media data of the new channel has been received. Thus, this disclosure describes techniques that enable delivery of media data of a new channel to a streaming client even without (e.g., before) delivering a manifest file associated with the new channel to the streaming client.

In particular, as explained in greater detail below, the proxy server and the streaming client may be configured to communicate according to a WebSocket Subprotocol. Thus, the proxy server may deliver media data to the streaming client via the WebSocket Subprotocol, rather than awaiting requests (e.g., HTTP GET requests) for the media data from the streaming client. The WebSocket Protocol is described in Fette et al., “The WebSocket Protocol,” Internet Engineering Task Force, RFC 6455, December 2011, available at tools.ietf.org/html/rfc6455. WebSocket Subprotocols are described in Section 1.9 of RFC 6455.

The techniques of this disclosure may utilize some or all of the techniques described in Walker et al., “TRANSPORT INTERFACE FOR MULTIMEDIA AND FILE TRANSPORT,” U.S. application Ser. No. 14/958,086, the entire contents of each of which are hereby incorporated by reference. The '086 application describes media data events (MDEs). MDEs may be used to reduce channel change times, e.g., for broadcast television (TV) services. These techniques may be relevant to linear TV, and particularly relevant to segment (that is, file-based) delivery services.

File-based or segment-based delivery services may be used, for example, when data is formatted according to DASH, among other services, and may be used in Real-Time Object Delivery over Unidirectional Transport (ROUTE) protocol, or File Delivery over Unidirectional Transport (FLUTE) as defined in Paila et al., “FLUTE—File Delivery over Unidirectional Transport,” Network Working Group, RFC 6726, November 2012, available at tools.ietf.org/html/rfc6726. Segment-based delivery techniques may be considered analogous to HTTP chunking, in which a larger payload is split into several smaller payloads. However, an important distinction between segment-based delivery techniques and HTTP chunking is that “chunks” (that is, MDEs) are generally provided for immediate consumption. That is, MDEs include playable media, and it is assumed that a receiver already has necessary media metadata (codecs, encryption metadata, etc.) to initiate playout of MDEs.

DASH solutions have recently been proposed for next-gen wireless video broadcast. DASH has been successfully used in conjunction with broadband access (that is, computer-network-based broadcast delivery). This allows a hybrid delivery approach. HTML and Javascript clients for DASH reception are configured to use broadband delivery. Broadcast technology rarely extends to web browser applications, but DASH clients (which may be embedded in web browser applications) may retrieve media data from a proxy server, which may form part of the same client device that is executing the web browser application.

DASH Javascript clients can leverage the Media Presentation Description (MPD), or other manifest files, to determine locations of content. The MPD is generally formed as an extensible markup language (XML) document. The MPD also provides indications of URL locations of media segments.

DASH Javascript clients may use browser-provided Javascript methods, such as XML-over-HTTP (XHR) to fetch segments. XHR can be used to perform chunked delivery for segments. In general, XHR is not used to release chunks (that is, partial segments) to Javascript, but instead, to release entire segments. Byte-range requests can be used to enable partial segment requests, but DASH clients generally are not able to determine a mapping between byte ranges and MDEs. The MPD could be extended to describe MDEs and associated byte ranges, but this would force DASH clients to acquire MPDS specifically tailored for fast channel change. The techniques of this disclosure may avoid this requirement.

As noted above, the techniques of this disclosure may utilize WebSockets and WebSocket Subprotocols. WebSockets were introduced into HTML 5 as a way to establish two-way communication between a web-based client and a server. URLs for WebSockets generally include a “ws://” prefix, or “wss://” for secure WebSockets. WebSocket(URL) is a main interface that has a readyState read only attribute (Connecting, Open, Closing, or Closed). Other read only attributes are defined in extension and the protocol, and are awaiting further specification. The WebSocket(URL) main interface propagates three events: onOpen, onError, and onClose. WebSocket(URL) also provides two methods: send( ) and close( ) Send( ) can take three arguments: a string, a blob, or an ArrayBuffer. The WebSocket(URL) main interface can access the read only attribute bufferedAmount(long) as part of send( ) handling. Extensive support for WebSockets is provided in a variety of web browsers, such as Mozilla Firefox, Google Chrome, or the like.

An example of a WebSocket declaration is shown below (where text following double slashes “II” at the start of a line represents unexecuted comments):
var connection=new WebSocket(‘ws://QRTCserver.qualcomm.com’);
//‘ws://’ and ‘wss://’ are new URL schemes for websocket and secure websocket respectively
//When the connection is open, send some data to the server connection.onopen=function ( ){connection.send(‘Ping’); //Send the message ‘Ping’ to the server
};
//Log errors
connection.onerror=function (error){console.log(‘WebSocket Error’+error);
};
//Log messages from the server connection.onmessage=function (e) {console.log(′Server: ‘+e.data);
};

The Internet Engineering Task Force (IETF) has a corresponding specification for WebSockets, specified in RFC 6455. UA is not originating a standard HTTPConnection upon WebSocket request. An HTTP handshake may occur over a TCP connection. The same connection can be re-used by other web applications connecting to the same server. The server may serve both “ws://” type requests and “http://” type requests.

An example of a client handshake and a server response from Section 1.2 of RFC 6455 are shown below:

Client Handshake:
GET/chat HTTP/1.1
Host: server.example.com
Upgrade: websocket
Connection: Upgrade
Sec-WebSocket-Key: dGhlIHNhbXBsZSBub25jZQ==
Origin: http://example.com
Sec-WebSocket-Protocol: chat, superchat
Sec-WebSocket-Version: 13

Server Response
HTTP/1.1 101 Switching Protocols
Upgrade: websocket
Connection: Upgrade
Sec-WebSocket-Accept: s3pPLMBiTxaQ9kYGzzhZRbK+xOo=
Sec-WebSocket-Protocol: chat

As explained in Section 1.9 of RFC 6455, a WebSocket Subprotocol may be formed by registering a Subprotocol Name using Section 11.5 of RFC 6455. In general, registration involves registering a subprotocol identifier, a subprotocol common name, and a subprotocol definition. To use the subprotocol, Section 11.3.4 of RFC 6455 indicates that a client device should include the subprotocol-specific header in a WebSocket opening handshake to a server device.

Specifying extensions or protocols in the HTTP handshake is optional. After the handshake is complete, data may be exchanged using a framing protocol, such as that defined in RFC 6455. That is, the data exchange may include an opcode to define a type of message (control, data, etc.), a mask (client-to-server data may be required to be masked, whereas server-to-client data may be required to be unmasked), a payload length, and payload data. A control frame indicating that the connection is to be closed may result in a “TCP FIN” message, which terminates the TCP connection.

Furthermore, DASH-based live streaming may leverage filecasting based on media segmentation. That is, a streaming server or other content preparation device may divide media data into distinct DASH segments. DASH segments are not playable without initialization information, which comes in the form of an Initialization Segment (IS). The IS contains initialization information to bootstrap codecs for tracks in the media segments. DASH segments can be self-initializing (i.e., media and initialization information are all included within same file container), but this is not efficient due to repetition of redundant information in each media segment.

Media playback (particularly using a web browser) typically involves initializing the media rendering process with an IS. In HTML5 rendering engines, the IS would be passed to a <video> tag, that is, a tag having “video” between two angle brackets, ‘<’ and ‘>’. During a live broadcast stream, an IS would rarely change. However, the initialization information in the IS can change, e.g., at an advertisement (ad) insertion point. If the IS changes, there needs to be a way to handle the change. In accordance with the techniques of this disclosure, a middleware unit of a client device may provide an implicit or explicit indication that media playback must be reinitialized to a media application/streaming client of the client device in response to the IS changing.

Typically, DASH clients running in a browser use pull-based media access. When using pull-based media access, DASH clients may leverage XML HTTP Requests (XHR) and associated HTTP semantics, such as HTTP GET requests. In order to use pull-based media access, DASH clients use a media presentation description (MPD) or other manifest file, which may be an XML file that provides segment retrieval information.

In accordance with the techniques of this disclosure, however, a DASH client (or other streaming client) may be implemented as a web browser plug-in, and may be configured to receive pushed data. For MPD-less delivery, the DASH client may use a sub-protocol for WebSockets with the middleware unit/proxy server, as a replacement to XHR. In this manner, the DASH client may use push-based media access. When the WebSocket connection is initialized to browser-based applications, such as the DASH client, the middleware unit initially pushes an initialization segment to the DASH client. It is assumed that broadcast emission carousels the IS frequently. Thus, after initially pushing the IS to the DASH client, the middleware unit may avoid pushing subsequent ISs to the DASH client (assuming the subsequent ISs are the same as the initial IS).

Table 8.1 of the ATSC 3.0 Interactive Content Specification lists several types of WebSocket (WS) connections that an application can establish with an ATSC 3.0 receiver, the latter three of which are useful for pushed (MPD-less) media that would be rendered by an Application Media Player (AMP). It is expected that when any of the media WS connections is established, the first media sent by the receiver will be the Initialization Segment (IS). The IS is used to initialize codecs (in the absence of self-initializing media segments), and is generally not expected to change rapidly in a live TV service. The IS is frequently sent as part of the broadcast emission, and can be downloaded by the broadcaster receiver with minimal delay upon service acquisition. However, there is a possibility that the IS may change in a broadcast emission due to changing media requirements, e.g. ad playback as part of the live broadcast. If this is the case, the AMP must reinitialize the playback engine (the source buffer of the HTML <video> tag).

The techniques of this disclosure may be applied to segments in the form of video files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

In HTTP streaming, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more periods. Periods may be defined by a Period element in the MPD. Each period may have an attribute start in the MPD. The MPD may include a start attribute and an availableStartTime attribute for each period. For live services, the sum of the start attribute of the period and the MPD attribute availableStartTime may specify the availability time of the period in UTC format, in particular the first Media Segment of each representation in the corresponding period. For on-demand services, the start attribute of the first period may be 0. For any other period, the start attribute may specify a time offset between the start time of the corresponding Period relative to the start time of the first Period. Each period may extend until the start of the next Period, or until the end of the media presentation in the case of the last period. Period start times may be precise. They may reflect the actual timing resulting from playing the media of all prior periods.

Each period may contain one or more representations for the same media content. A representation may be one of a number of alternative encoded versions of audio or video data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

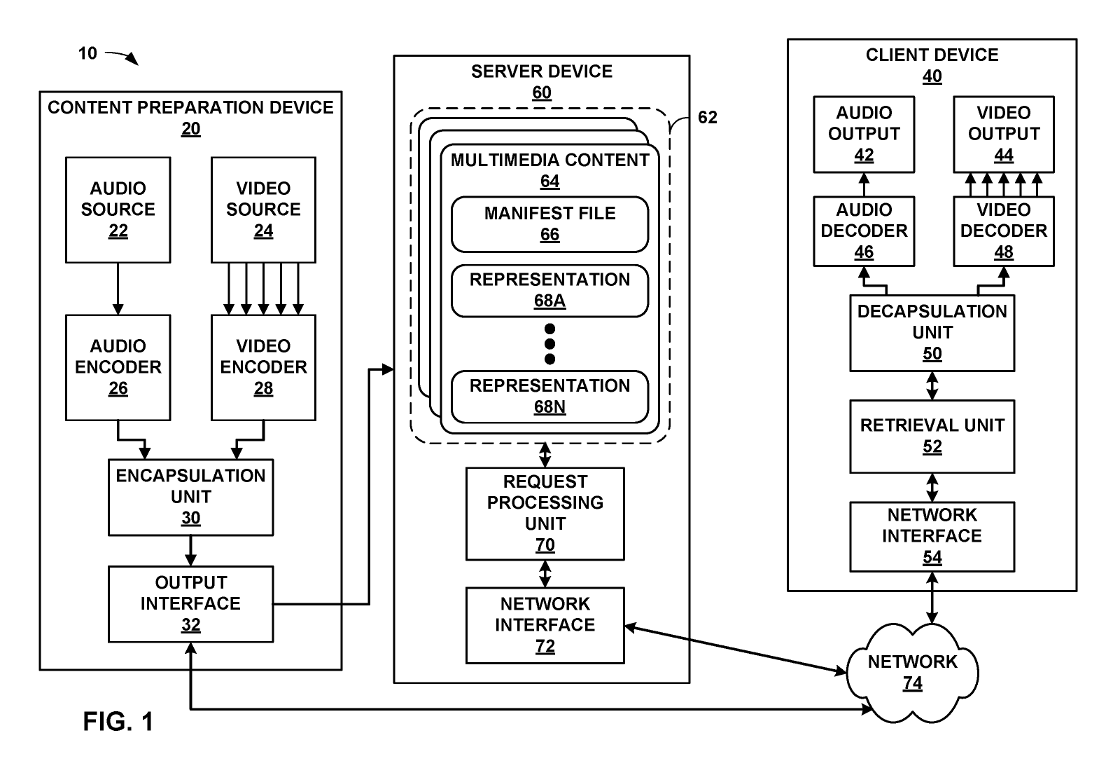

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, includes audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the High Efficiency Video Coding (HEVC) standard (also referred to as ITU-T H.265), define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. In the example of H.264/AVC (Advanced Video Coding), coded video segments are organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture, hence coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

Furthermore, in accordance with certain techniques of this disclosure, server device 60 may transmit media data to client device 40 via an over-the-air (OTA) broadcast. That is, rather than delivering media data via network 74, server device 60 may transmit media data via an OTA broadcast, which may be sent via antennas, satellites, cable television provider, or the like.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

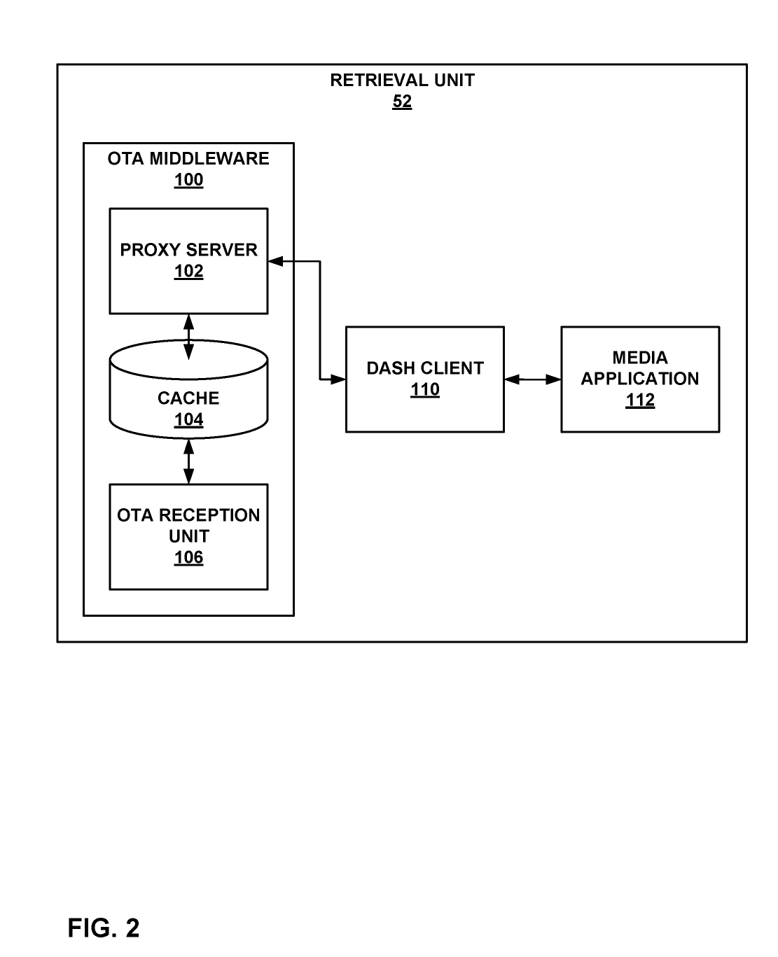

As noted above, retrieval unit 52, in some examples, may be configured to receive an OTA broadcast from server device 60. In such examples, retrieval unit 52 may include an OTA reception unit and a streaming client, e.g., as shown in and described in greater detail with respect to FIG. 2 below. In general, the streaming client (e.g., a DASH client) may be configured to be push-enabled. That is, the streaming client may receive media data from the proxy server without first requesting the media data from the proxy server. Thus, the proxy server may push the media data to the streaming client, rather than delivering the media data in response to a request for the media data from the streaming client.

Push-enabled technology may improve performance in fast channel changes. Thus, if retrieval unit 52 determines that a channel change event has occurred (that is, that the current channel has switched from a previous channel to a new channel), the proxy server may push media data of the new channel to the streaming client. Rather than using XHR, retrieval unit 52 may be configured to use WebSockets to effect this push-based delivery. Thus, channel change events may be incorporated through channel tuner-originated events. For instance, the techniques of this disclosure for channel change and push-based delivery may bypass Javascript, and the proxy server may determine that a channel change event has occurred. In response to the channel change event, the proxy server may immediately begin delivering MDEs, in place of segments, to the streaming client. In some examples, the proxy server provides information describing the channel change “in band” with the media data to the streaming client, e.g., through the WebSocket connection to the streaming client.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

FIG. 2 is a block diagram illustrating an example set of components of retrieval unit 52 of FIG. 1 in greater detail. In this example, retrieval unit 52 includes OTA middleware unit 100, DASH client 110, and media application 112.

In this example, OTA middleware unit 100 further includes OTA reception unit 106, cache 104, and proxy server 102. In this example, OTA reception unit 106 is configured to receive data via OTA, e.g., according to ATSC 3.0. In some examples, a middleware unit, such as OTA middleware unit 100, may be configured to receive data according to a file-based delivery protocol, such as File Delivery over Unidirectional Transport (FLUTE) or Real-Time Object Delivery over Unidirectional Transport (ROUTE). That is, the middleware unit may receive files via broadcast from, e.g., server device 60, which may act as a broadcast multicast service center (BM-SC).

As OTA middleware unit 100 receives data for files, OTA middleware unit may store the received data in cache 104. Cache 104 may comprise a computer-readable storage medium (e.g., a memory), such as flash memory, a hard disk, RAM, or any other suitable storage medium.

Proxy server 102 may act as a proxy server for DASH client 110. For example, proxy server 102 may provide a MPD file or other manifest file to DASH client 110. Proxy server 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from proxy server 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server 102. Proxy server 102 may retrieve requested data from cache 104 and provide the data to DASH client 110 in response to such requests.

In some examples, proxy server 102 pushes media data events (MDEs) of a new channel to DASH client 110 before (or without) sending the MPD for the new channel to DASH client 110. Thus, in such examples, proxy server 102 may send media data of the new channel to DASH client 110 without actually receiving requests for the media data from DASH client 110. Proxy server 102 and DASH client 110 may be configured to execute a WebSocket Subprotocol to enable such media data pushing.

In general, WebSockets allow for definition of subprotocols. For example, RFC 7395 defines an Extensible Messaging and Presence Protocol (XMPP) Subprotocol for WebSockets. The techniques of this disclosure may use a WebSocket Subprotocol in a similar manner. In particular, proxy server 102 and DASH client 110 may negotiate the WebSocket Subprotocol during an HTTP handshake. Data for the subprotocol may be included in a Sec-WebSocket-Protocol header during this HTTP handshake. In some examples, the Subprotocol negotiation can be avoided, e.g., if it is known a priori that both ends of the WebSocket are using a common subprotocol.

Further, the definition of the subprotocol may retain a subset of HTTP 1.1/XHR semantics. For example, the subprotocol may include the use of a text-based GET URL message. Other methods, such as PUSH, PUT, and POST are not necessary in the subprotocol. HTTP error codes are also unnecessary, because WebSocket error messages are sufficient. Nevertheless, in some examples, other methods (e.g., PUSH, PUT, and POST, and/or HTTP error codes) may be included in the subprotocol.

In general, the subprotocol may propagate MDE events through WebSockets. This may allow leveraging of direct access to tuner events. The subprotocol may include client-to-server messaging, e.g., in the form of text-based messages that specify a URL. The server (e.g., proxy server 102) may parse incoming text from the client (e.g., DASH client 110). In response, proxy server 102 may provide a segment in return. Proxy server 102 may interpret such messages as HTTP GET messages.

Server-to-client messaging of the subprotocol may include both text-based messages and binary-based messages. The text-based messages may include “START SEGMENT” and/or “END SEGMENT” to indicate that data for a segment has started or ended. “END SEGMENT” may be sufficient in some examples for synchronous delivery, e.g., when segments are only delivered in response to a GET or channel change. In some examples, the message may further include a URL for the corresponding segment (e.g., in the form of “END [URL]”).

The text-based messages from proxy server 102 to DASH client 110 may also include “CHANNEL CHANGE” to indicate that a channel change has occurred and that a new segment is forthcoming. The “CHANNEL CHANGE” message may include a segment URL for the new segment, as DASH client 110 may not have yet acquired an MPD for the new channel. In some examples, the text-based messages may include “MPD” to indicate that an MPD is being delivered to DASH client 110. Proxy server 102 may push the MPD in-band to DASH client 110 (that is, together with media data corresponding to the MPD), or DASH client 110 may retrieve the MPD out of band. If retrieved out of band, then proxy server 102 may provide an in-band MPD URL message indicative of the URL for the MPD to DASH client 110.

The binary message from proxy server 102 to DASH client 110 may include media payloads. For example, the media payloads may include full segments or MDEs. If MDEs are delivered, proxy server 102 may be configured to ensure that the MDEs are delivered in sequence to DASH client 110.

In accordance with the techniques of this disclosure, OTA middleware unit 100 may be configured to determine whether initialization information of two initialization segments is different and thus requiring reinitialization by media application 112. That is, if the initialization information of a subsequently received initialization segment is the same as initialization information of a previously received initialization segment, OTA middleware unit 100 need not instruct media application 112 to reinitialize. On the other hand, if the initialization information of the subsequent initialization segment is different, OTA middleware unit 100 may send data to media application 112 to cause media application 112 to reinitialize using the new initialization information of the subsequent initialization segment.

In this manner, client device 40 represents an example of a device for retrieving media data including a memory configured to store media data (e.g., cache 104), and a middleware unit (e.g., OTA middleware unit 100) comprising one or more processors implemented in circuitry and configured to receive a first initialization segment of a broadcast stream of media data, receive a second initialization segment of the broadcast stream of media data. determine whether initialization information of the second initialization segment is different than initialization information of the first initialization segment, in response to determining that the initialization information of the second initialization segment is different than the initialization information of the first initialization segment, send an indication to a media application (e.g., media application 112) that media playback is to be reinitialized using the initialization information of the second initialization segment, and in response to determining that the initialization information of the second initialization segment is the same as the initialization information of the first initialization segment, send media data of the broadcast stream received following the second initialization segment to the media application without sending the indication to the media application that the media playback is to be reinitialized.

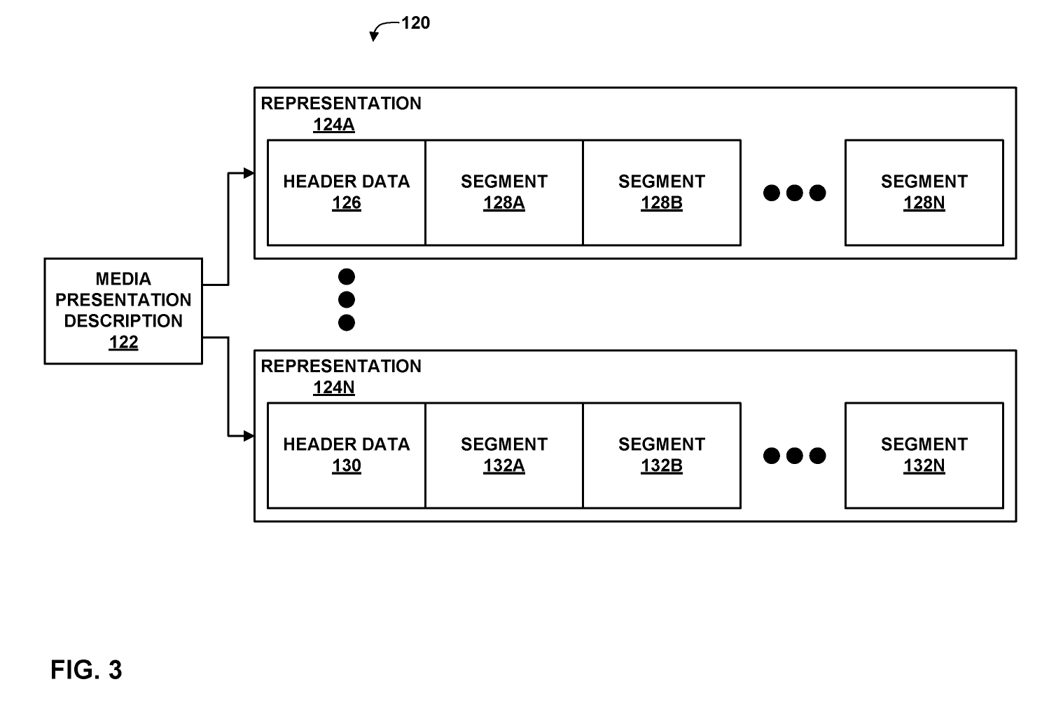

FIG. 3 is a conceptual diagram illustrating elements of example multimedia content 120. Multimedia content 120 may correspond to multimedia content 64 (FIG. 1), or another multimedia content stored in storage medium 62. In the example of FIG. 3, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124A-124N. MPD 122 may correspond to manifest file 66 of FIG. 1. Likewise, representations 124A-124N may correspond to representations 68 of FIG. 1. In general, MPD 122 may include data that generally describes characteristics of representations 124A-124N, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 3. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

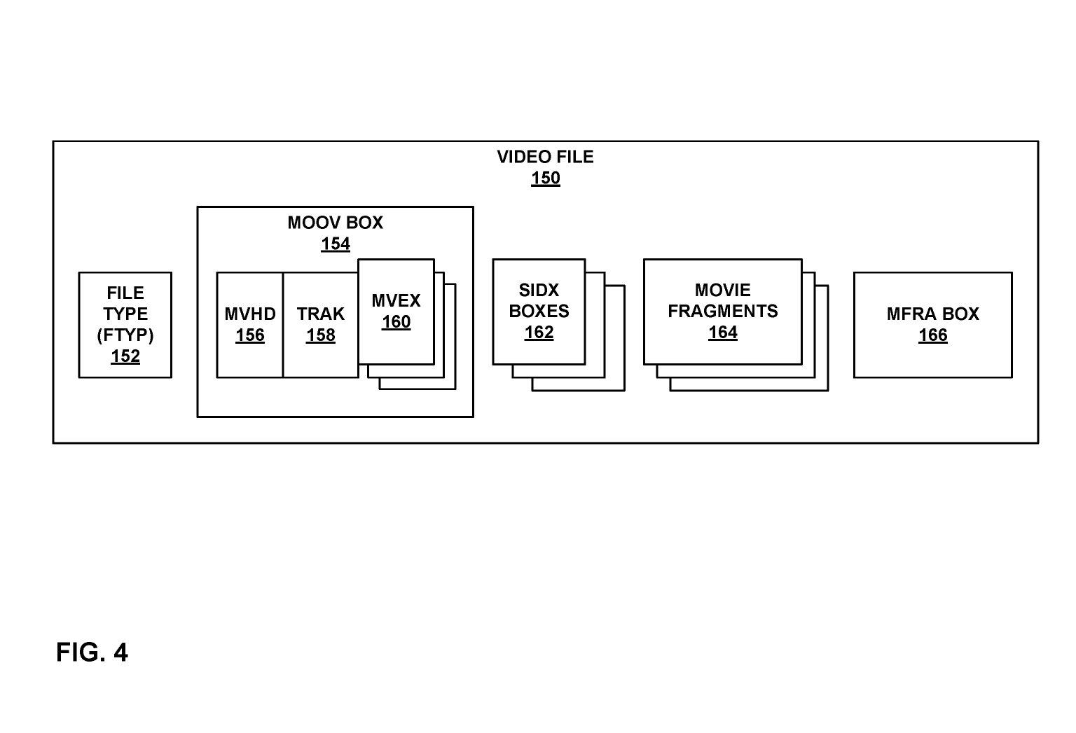

FIG. 4 is a block diagram illustrating elements of an example video file 150, which may correspond to a segment of a representation, such as one of segments 128, 132 of FIG. 3. Each of segments 128, 132 may include data that conforms substantially to the arrangement of data illustrated in the example of FIG. 4. Video file 150 may be said to encapsulate a segment. As described above, video files in accordance with the ISO base media file format and extensions thereof store data in a series of objects, referred to as “boxes.” In the example of FIG. 4, video file 150 includes file type (FTYP) box 152, movie (MOOV) box 154, segment index (sidx) boxes 162, movie fragment (MOOF) boxes 164, and movie fragment random access (MFRA) box 166. Although FIG. 4 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150.

MOOV box 154, in the example of FIG. 4, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 3) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units which contains the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 4). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

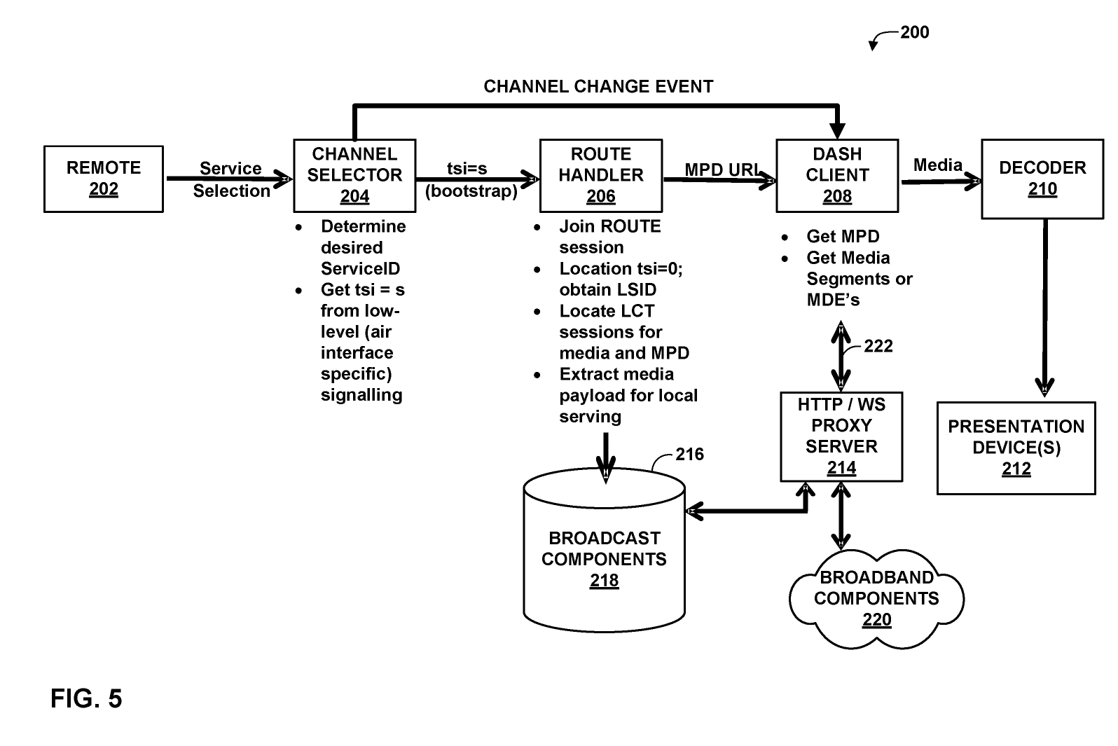

FIG. 5 is a block diagram illustrating an example system 200 that may perform the techniques of this disclosure. The system of FIG. 5 includes remote 202, channel selector 204, ROUTE handler 206, DASH client 208, decoder 210, HTTP/WS proxy server 214, a data storage device 216 storing broadcast components 218, broadband components 220, and one or more presentation devices 212. Broadcast components 218 may include, for example, a manifest file (such as a media presentation description (MPD)) and media data or media deliver event (MDE) data.

The elements of FIG. 5 may generally correspond to the elements of client device 40 (FIG. 1) and components thereof (e.g., retrieval unit 52 as shown in FIG. 2). For example, channel selector 204 and broadband components 220 may correspond to network interface 54 (or an OTA reception unit, not shown in FIG. 1), ROUTE handler 206, DASH client 208, proxy server 214, and data storage device 216 may correspond to retrieval unit 52, decoder 210 may correspond to either or both of audio decoder 46 and video decoder 48, and presentation device(s) 212 may correspond to audio output 42 and video output 44.

In general, proxy server 214 may provide manifest files, such as MPDs, to DASH client 208. However, even without delivering an MPD to DASH client 208, proxy server 214 may push MDEs of media data of a channel (e.g., a new channel following a channel change event) to DASH client 208. In particular, a user may request a channel change event by accessing remote 202, which sends a channel change instruction to channel selector 204.

Channel selector 204 may comprise, for example, an over-the-air (OTA) channel tuner, a cable set-top box, a satellite set-top box, or the like. In general, channel selector 204 is configured to determine service identifiers (serviceIDs) for channels selected via a signal received from remote 202. Channel selector 204 also determines a transport session identifier (TSI) for the service corresponding to the serviceID. Channel selector 204 provides the TSI to ROUTE handler 206.

ROUTE handler 206 is configured to operate according to the ROUTE protocol. For example, ROUTE handler 206, in response to receiving a TSI from channel selector 204, joins a corresponding ROUTE session. ROUTE handler 206 determines layered coding transport (LCT) sessions for the ROUTE session, by which to receive media data and a manifest file for the ROUTE session. ROUTE handler 206 also obtains an LCT Session Instance Description (LSID) for the LCTs. ROUTE handler 206 extracts media data from ROUTE-delivered data and caches the data to broadcast components 218.

Accordingly, proxy server 214 can retrieve media data from broadcast components 218 for subsequent delivery to DASH client 208. In particular, when performing HTTP, proxy server 214 provides such media data (and the manifest file) to DASH client 208 in response to specific requests for the media data. However, when performing WebSockets, proxy server 214 can “push” media data (e.g., received via broadband components 220 or retrieved from broadcast components 218) to DASH client 208. That is, proxy server 214 can deliver the media data after the media data is ready for delivery, without receiving individual requests for the media data from DASH client 208. Proxy server 214 and DASH client 208 may establish a WebSocket connection, such as WebSocket connection 222.

DASH client 208 can still receive channel change events directly from the local tuner (that is, channel selector 204), but may not be able to act on them in a timely manner. Thus, by pushing MDEs of the media data of the new channel to DASH client 208, DASH client 208 may be able to extract useable media data from the MDEs, even without the manifest file.

DASH client 208 and proxy server 214 may each be implemented in hardware, or a combination of software and/or firmware and hardware. That is, when software and/or firmware instructions for DASH client 208 or proxy server 214 are provided, it should be understood that requisite hardware (such as a memory to store the instructions and one or more processing units to execute the instructions) are also provided. The processing units may comprise one or more processors, such as one or more digital signal processors (DSPs), general purpose microprocessors, application specific integrated circuits (ASICs), field programmable logic arrays (FPGAs), or other equivalent integrated or discrete logic circuitry, alone or in any combination. In general, a “processing unit” should be understood to refer to a hardware-based unit, that is, a unit including some form of circuitry, which may include fixed function and/or programmable circuitry.

In the example of FIG. 5, a middleware unit (not shown in FIG. 5) may include ROUTE handler 206, channel selector 204, broadcast components 216, and HTTP/WS proxy server 214. DASH client 208 may be implemented in a web browser executed by a separate processor. HTTP/WS proxy server 214 (co-located with ROUTE handler 206, which represents a broadcast receiver) may push segments over a WebSocket connection to DASH client 208 as the segments are received, even in absence of a manifest file, such as an MPD. The MPD may be delivered later in time, at which point DASH client 208 may switch to a media pull approach (e.g., sending HTTP GET or partial GET requests to HTTP/WS proxy server 214).

In accordance with the techniques of this disclosure, ROUTE handler 206 may periodically receive initialization segments (ISs). Rather than discarding ISs after a first-received IS, ROUTE handler 206 (or HTTP/WS proxy server 214) may determine whether a subsequently-received IS includes different initialization information than the first-received IS. In response to receiving a new, different set of initialization information in an IS, HTTP/WS proxy server 214 may send an indication to DASH client 208 that media playback needs to be reinitialized.

In one example, to send the indication that media playback is to be reinitialized, HTTP/WS proxy server 214 terminates WebSocket connection 208 upon detection of a new IS in a broadcast emission. Termination of WebSocket connection 208 may cause DASH client 208 to reestablish WebSocket connection 208 and to re-initialize media playback.

In another example, HTTP/WS proxy server 214 sends an in-band indication of the new IS to DASH client 208 via WebSocket connection 208. The message may indicate that a previously-delivered IS is no longer valid, and that HTTP/WS proxy server 214 will send a new IS via WebSocket connection 208.

In another example, HTTP/WS proxy server 214 sends an out-of-band indication of the new IS to DASH client 208, separate from WebSocket connection 208. For example, HTTP/WS proxy server 214 may send a message using a special signaling channel (not shown) between HTTP/WS proxy server 214 and DASH client 208. To address potential timing issues between WebSocket connection 208 and the separate, special signaling channel, HTTP/WS proxy server 214 may include an indication of relative timing in the message, or in addition to the message, sent via the special signaling channel.

Accordingly, a broadcast receiver can detect a changing IS using several different methods. One possible method is indication of a changing IS in the Codepoint field of the LCT packet. Another could be simple checksum verification by the receiver of an incoming IS. Upon recognition and receipt of a new IS after a WS media connection has been opened, the broadcast receiver should indicate to the AMP that a new IS is forthcoming. This can be accomplished by insertion of a special text message in the WS connection, which would then be followed by the media itself. The expected behavior of the AMP would be to create a new source buffer and initialize accordingly.

Additionally or alternatively, the AMP could inspect each segment received over a media WS connection to determine if it is an IS. This may involve processing of binary data, e.g., in Javascript. The IS indication could be sent out-of-band, e.g., via a command & control WS connection. However, this may involve temporal synchronization between the command & control WS connection and the media WS connection. The broadcast receiver could terminate the media WS connection upon detection of a new IS. This would force the AMP to re-establish the media WS connection and receive a new IS. This may add overhead to the establishment of a WS connection upon receipt of a new IS.

A new Section may be added to 534-4-252-WD-Interactive-Content-Specification (entitled “ATSC Working Draft: ATSC 3.0 Interactive Content, A/344”), as follows:
Section 8.2.1.1 Initializing Pushed Media WebSocket Connections Upon establishment of any of the media WebSocket connections listed in Table 8.1 (atscVid, atscAud), it is expected that the first data sent by the broadcast receiver over such a connection is an Initialization Segment. If a new Initialization Segment is received after establishment of the media WebSocket connection, then the broadcast receiver will send a text message over the same WebSocket connection (opcode 0x1, as defined in Section 5.2 of IETF RFC 9455) with the payload “IS”. Then the broadcast receiver will send the new Initialization Segment followed by ensuing media segments.

In this manner, system 200 represents an example of a device for transferring media data, the device including a memory configured to store media data and one or more processors configured to execute a middleware unit (e.g., a proxy server) for a client device including a media application (that is, a streaming client). The middleware unit is configured to receive a first initialization segment of a broadcast stream of media data, receive a second initialization segment of the broadcast stream of media data, determine whether initialization information of the second initialization segment is different than initialization information of the first initialization segment, and in response to determining that the initialization information of the second initialization segment is different than the initialization information of the first initialization segment, send an indication to the media application that media playback is to be reinitialized using the initialization information of the second initialization segment.

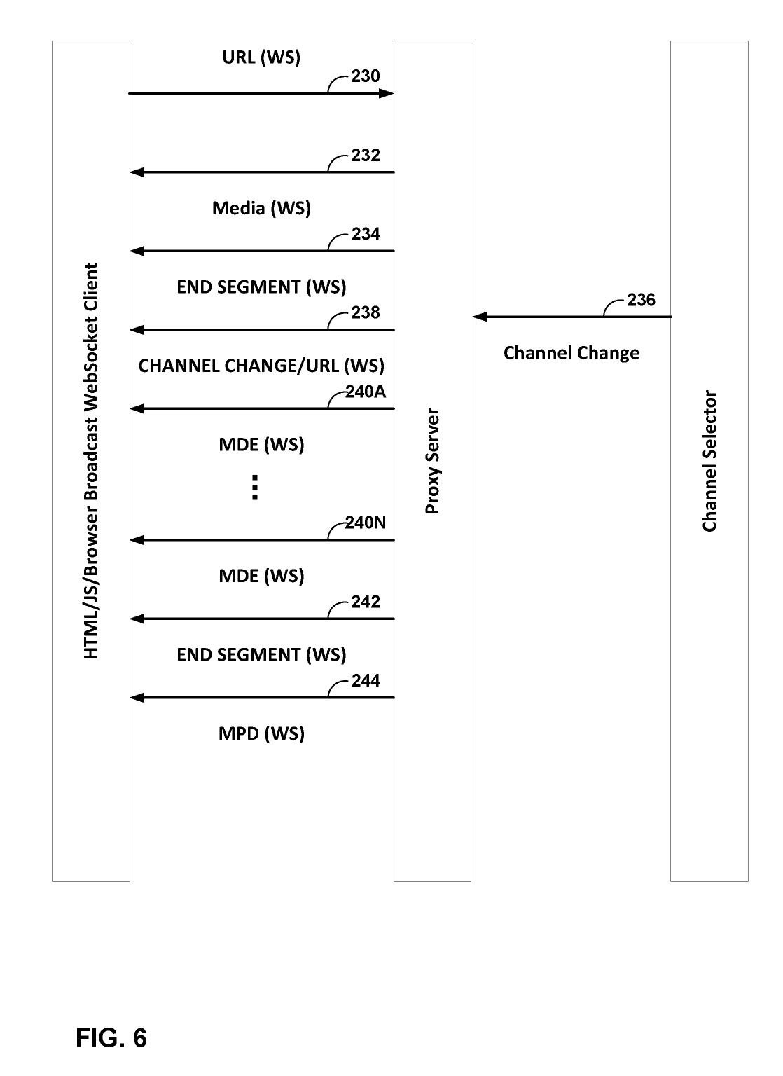

FIG. 6 is a flow diagram illustrating an example communication exchange between components of system 200 of FIG. 5. Although explained with respect to the components of system 200 of FIG. 5, the techniques of FIG. 5 may also be performed by other devices and systems, e.g., client device 40 of FIG. 1 and retrieval unit 52 of FIG. 2. In particular, the example flow diagram of FIG. 6 is described with respect to channel selector 204, proxy server 214, and DASH client 208.

In the example of FIG. 6, DASH client 208 (labeled “HTML/JS/Browser Broadcast WebSocket Client” in FIG. 6) sends a URL of a segment to proxy server 214 (labeled “Local HTTP Proxy” in FIG. 6) (URL (WS)) (230). That is, as explained above, DASH client 208 may send a text-based message, using a WebSocket, to proxy server 214, where the message specifies a URL of a segment. The URL may include a “ws://” prefix or a “wss://” prefix. In response, proxy server 214 sends media data using the WebSocket to DASH client 208 (232) in the form of segments, as well as text-based messages indicating the ends of the segments (Media (WS)) (234).

After this series of communications, channel selector 204 indicates that the channel has been changed (236) (e.g., after having received a signal from remote 202, not shown in FIG. 6). In response, in this example, proxy server 214 sends a text-based message via the WebSocket to DASH client 208 indicating that the channel has changed, as well as a URL of the new channel (238). Furthermore, proxy server 214 delivers one or more media data events (MDEs) including media data of the new channel to DASH client 208 (240A-240N). As shown in FIG. 6, delivery of the MDEs occurs before delivery of an MPD for the new channel to the DASH client (244). However, in some examples, proxy server 214 may never actually deliver the MPD to DASH client 208. Furthermore, following delivery of the MPD, proxy server 214 may continue to deliver MDEs to DASH client 208, if the MPD is in fact delivered as shown.

After delivering the MDEs of a segment to DASH client 208 via the WebSocket, proxy server 214 delivers a text-based message indicating the end of the segment (242). Although only a single segment is represented in FIG. 6, it should be understood that this process may occur repeatedly for multiple segments. That is, proxy server 214 may deliver MDEs for a plurality of segments, followed by an “END SEGMENT” message or similar message (e.g., similar text-based message) indicating that the segment has ended. In the example of FIG. 6, delivery of the MDEs (242) and delivery of the end of the segment (242) occurs before delivery of an MPD for the new channel to the DASH client (244).

Although not shown in FIG. 6, after delivering data of the segments, DASH client 208 may extract media data from the segments and deliver the extracted media data to corresponding decoders for presentation. With respect to FIG. 5, for example, DASH client 208 may deliver the extracted media data to decoder 210. Decoder 210, in turn, may decode the media data and deliver the decoded media data to presentation device(s) 212 for presentation.

In this manner, the method of FIG. 6 represents an example of a method of transferring media data that includes, by a middleware unit (e.g., a proxy server) for a client device including a media application (e.g., a streaming client), receiving a first initialization segment of a broadcast stream of media data, receiving a second initialization segment of the broadcast stream of media data, determining whether initialization information of the second initialization segment is different than initialization information of the first initialization segment, and in response to determining that the initialization information of the second initialization segment is different than the initialization information of the first initialization segment, sending an indication to the media application that media playback is to be reinitialized using the initialization information of the second initialization segment.

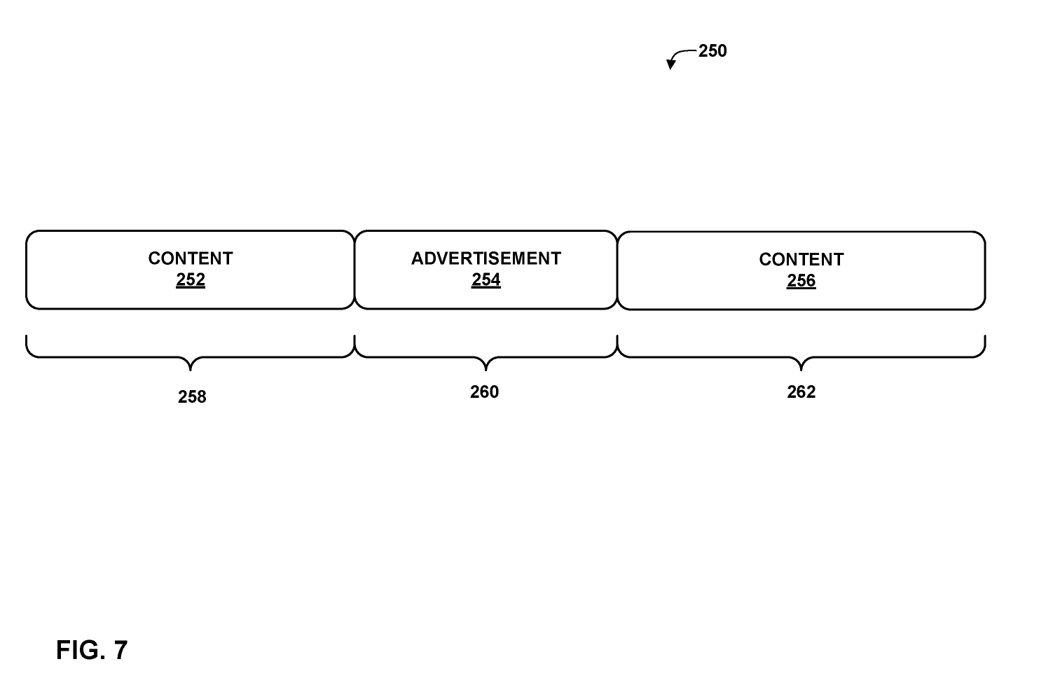

FIG. 7 is a conceptual diagram illustrating an example set of media content 250. ROUTE supports MDE based delivery. Therefore, a streaming client (such as DASH client 208 of FIG. 5) can initiate playout when a sufficient amount of a media segment has been received. Two different types of reception are available: MPD-less reception, and MPD-based reception.

Within MPD-less MDE based ROUTE reception, the techniques of this disclosure may be used to address the problem of advertisement (AD) insertion or other multi-period services. As shown in FIG. 7, media content 250 includes content 252, advertisement 254, and content 256. Content 252 corresponds to period 258, advertisement 254 corresponds to period 260, and content 256 corresponds to period 262. AD insertion may be accomplished using a multi-period service as shown in the example of FIG. 7.

For a smooth playout of media content 250, ROUTE handler 206 of FIG. 5 should communicate to DASH client 208 information representing boundaries between periods 258, 260, and 262. During the beginning of advertisement 254, DASH client 208 may clear out all the source buffers and reinitialize these buffers again. Absent this reinitialization, MDE-based reception might not operate correctly. Further information on MDE-based reception and reinitialization is discussed at github.com/Dash-Industry-Forum/dash.js/issues/126.

In the absence of information that would otherwise be provided by the MPD, two problems may arise. First, there should be a way for ROUTE handler 206 to identify period boundaries. Second, ROUTE handler 206 should be able to communicate the identified period boundaries to DASH client 208. This disclosure describes various techniques that may address both of these issues.

With respect to identification of period boundaries, various example techniques may be used. In one example, ROUTE handler 206 may use code point (CP) assignment in a layered coding transport (LCT) packet header to identify a period boundary. In another example, ROUTE handler 206 may use checksums for initialization segments to determine period boundaries. In general, period boundaries also correspond to new sets of initialization information in new initialization segments (ISs). Thus, detection of a period boundary also provides an indication that a new IS, including new initialization information, has been received. In this manner, ROUTE handler 206 may determine that initialization information of an initialization segment at the start of a period boundary is new, and thus, that reinitialization is necessary.

This disclosure also describes various techniques for communicating identified period boundaries from ROUTE handler 206 to DASH client 208. In one example, ROUTE handler 206 (or HTTP/WS proxy server 214) may close and reopen/reestablish WebSocket connection 222. In another example, ROUTE handler 206 or HTTP/WS proxy server 214 may send a text message frame through WebSocket connection 222 as a cue message representative of the new period boundary (and hence, new initialization information). In yet another example, ROUTE handler 206 or HTTP/WS proxy server 214 may send an out-of-band message representative of the new period boundary.

Table 1 below provides semantics for various Code Point values that may be assigned to Code Point syntax elements in an LCT packet header. That is, Table 1 provides examples of the syntax and semantics of the Code Point and usage in the absence of information provided by an MPD for handling content period boundaries.

TABLE 1

| Code | |
|---|---|
| Point | Semantics |
| 0 | Object Type described in FDT, unfragmented (whole packet |
| | contains IS, no ROUTE header) |
| 1 | Object Type described in FDT, 32 bit ROUTE header |
| 2 | New IS, timeline discontinuity, unfragmented (i.e. whole packet |
| | contains IS, no ROUTE header) |
| 3 | New IS, timeline changed, fragmented, 32 bit ROUTE header |
| 4 | New IS, timeline continued, unfragmented (i.e. whole packet |
| | contains IS, no ROUTE header) |
| 5 | New IS, timeline continued, fragmented, 32 bit ROUTE header |
| 6 | Redundant IS, unfragmented (i.e. whole packet contains IS, |
| | no ROUTE header) |
| 7 | Redundant IS, fragmented, 32 bit ROUTE header |
| 8 | Media Segment unfragmented |
| 9 | Media Segment fragmented |
| 10 | Object in Entity Mode unfragmented |
| 11 | Object in Entity Mode fragmented |
| 12-127 | Reserved for static object association |
| 128-255 | Dynamic code point allocation through LSID |

Accordingly, values of 2, 3, 4, and 5 for the CP syntax element represent that a corresponding IS is a new IS. Therefore, using the value for the CP syntax element, ROUTE handler 206 and/or HTTP/WS proxy unit 214 may determine that an IS is a new IS when a corresponding LCT packet header includes a value of 2, 3, 4, or 5 for a CP syntax element. In this manner, by simply observing the CP field in the LCT header of the IS, one can clearly recognize whether the IS is a new IS, and additionally, if a timeline is discontinued (e.g., an advertisement, for values of 2 and 3) or continued (e.g., for a regular continuous period, for values of 4 and 5). Thus, in some examples, values of 2 or 3 for the CP field indicate a period boundary, and other CP values do not indicate a period boundary.

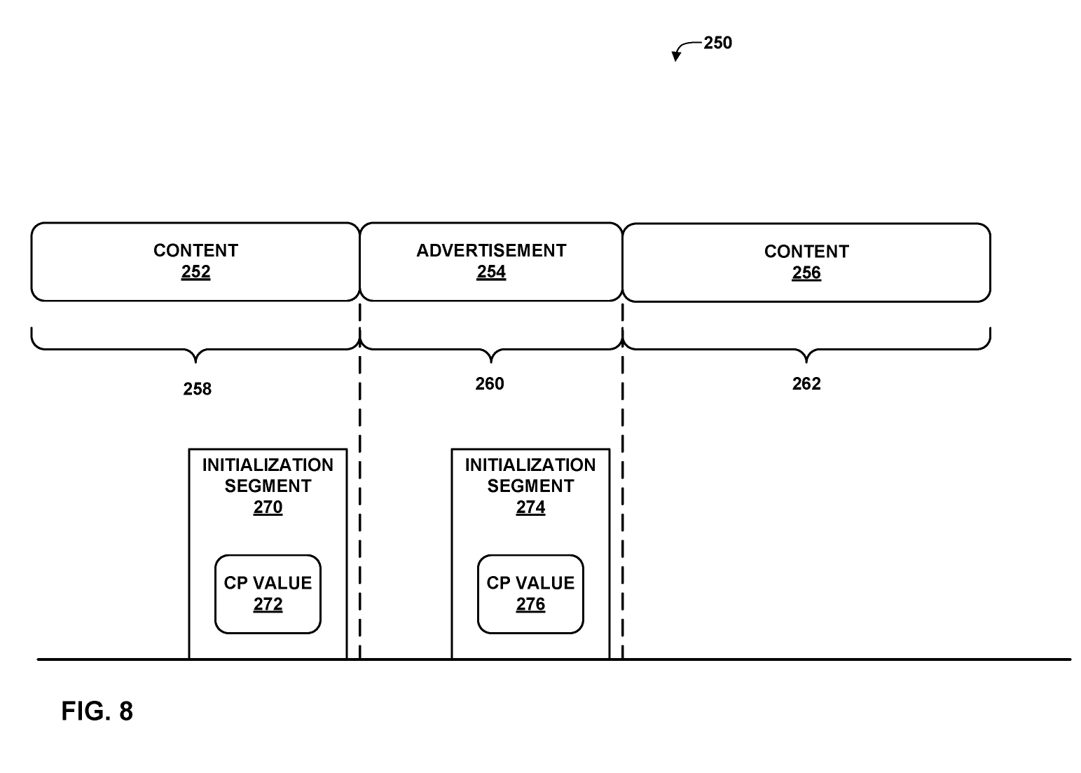

FIG. 8 is a conceptual diagram illustrating an example set of initialization segments that may be received during media streaming. FIG. 8 illustrates an example of a multi-period presentation corresponding to FIG. 7. In particular, FIG. 8 illustrates example initialization segments 270, 274 (other segments are not shown, but it should be understood that additional segments would be included in the broadcast stream). Initialization segment 270 includes Code Point (CP) value 272, and initialization segment 274 includes CP value 276. CP value 272 may be set to 2 or 3, and CP value 276 may be set to 2 or 3.

In MDE reception, the content boundary between Periods may be signaled in CP fields 272, 276 of LCT headers (not shown) in initialization segments (ISs) 270, 274. The value of CP fields 272, 276 may be set either to 2 or 3, indicating that this is a new IS (and the timeline is not continuous). ROUTE handler 206 and/or HTTP/WS proxy server 214 may take appropriate action based on these values, e.g., as discussed in greater detail below. In general, ROUTE handler 206 and/or HTTP/WS proxy server 214 may provide an indication to DASH client 208 that a previous IS is invalid and that a new IS is forthcoming in response to detecting a code point value of 2 or 3.

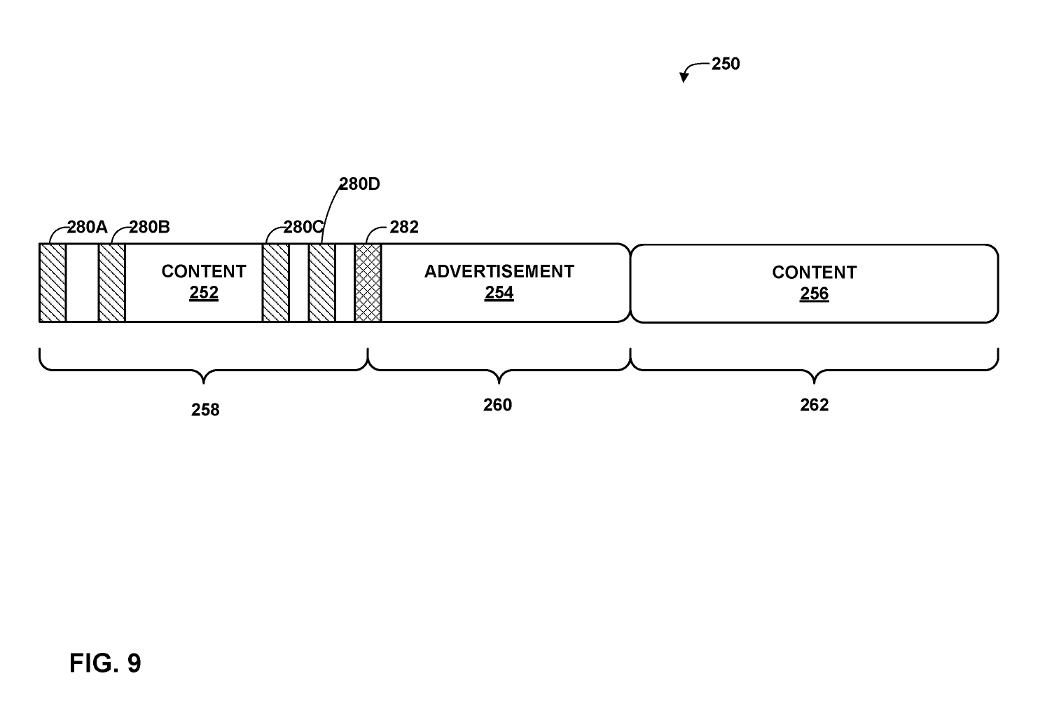

FIG. 9 is a conceptual diagram illustrating another example technique for determining whether a new IS has been received (and thus, detecting a period boundary). In this example, ROUTE handler 206 and/or HTTP/WS proxy server 214 initially receives IS 280A, and stores a checksum of IS 280A. Throughout the media stream, ROUTE handler 206 and/or HTTP/WS proxy server 214 receives subsequent ISs 280B, 280C, 280D, and 282, and compares checksums for ISs 280B, 280C, 280D, and 282 to the checksum for IS 280A. In this example, ROUTE handler 206 or HTTP/WS proxy server 214 determines that checksums for ISs 280B, 280C, and 280D are equal to the checksum for IS 280A, and thus, determines that ISs 280B, 280C, and 280D are the same as IS 280A, and thus, discards ISs 280B, 280C, and 280D without forwarding ISs 280B, 280C, and 280D to DASH client 208.

However, ROUTE handler 206 and/or HTTP/WS proxy server 214 determines, in this example, that IS 282 has a checksum that is different than the checksum for IS 280A. Accordingly, ROUTE handler 206 and/or HTTP/WS proxy server 214 determines that IS 282 represents a period boundary between periods 258 and 260, and thus, sends an indication to DASH client 208 that media playback is to be reinitialized.

Accordingly, the example of FIG. 9 represents an example of a technique by which ROUTE handler 206 and/or HTTP/WS proxy server 214 keep comparing the checksum value of every incoming IS. If the checksum of the newly received IS is the same as the checksum of the previously used IS, then ROUTE handler 206 and/or HTTP/WS proxy server 214 may determine that the newly received IS is not a new IS. On the other hand, if the checksum is different, then ROUTE handler 206 and/or HTTP/WS proxy server 214 may determine that the newly received IS is a new IS, and hence, represents a period boundary. ROUTE handler 206 and/or HTTP/WS proxy server 214 may therefore communicate this information to DASH client 208, which may take further actions, such as reinitializing media playback using new initialization information of the newly received IS.

In some examples, the techniques of FIGS. 8 and 9 may be used in conjunction. For example, ROUTE handler 206 and/or HTTP/WS proxy server 214 may use a CP value to determine whether a packet corresponds to an IS, and then determine whether the IS is a new IS, i.e., includes new initialization information (e.g., based on the CP value and/or the checksum).

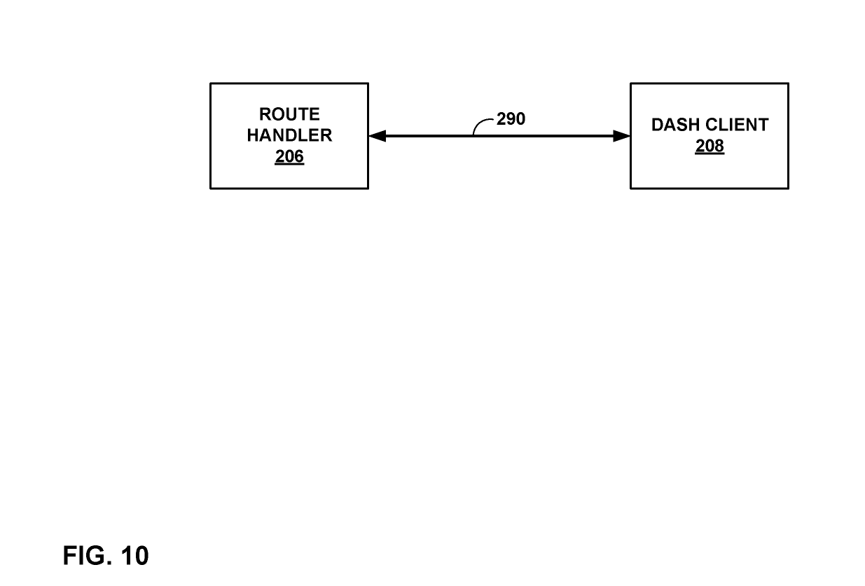

FIG. 10 is a block diagram illustrating ROUTE handler 206 and DASH client 208 of FIG. 5 as participating in a WebSocket connection 290. In some examples, WebSocket connection 290 may be the same as WebSocket connection 222 of FIG. 5 (e.g., because a common middleware unit includes both ROUTE handler 206 and HTTP/WS proxy server 214).

In this example, ROUTE handler 206 and DASH client 208 are connected via WebSocket connection 290. After ROUTE handler 206 identifies a period boundary, ROUTE handler 206 may send an indication of the period boundary to DASH client 208, e.g., via WebSocket connection 290. Various examples for communicating this indication are possible.

In one example, ROUTE handler 206 may close and reopen WebSocket connection 290. In this example, after ROUTE handler 206 identifies that has received a new IS (that is, at the period boundary), ROUTE handler 206 closes WebSocket connection 290 and reopens WebSocket connection 290. This triggers the “onclose” event at DASH client 208, as discussed at developer.mozilla.org/en-US/docs/Web/API/CloseEvent.

In another example, ROUTE handler 206 sends a text message frame as a cue message to DASH client 208. That is, ROUTE handler 206 may directly send a control cue message through WebSocket connection 290 to DASH client 208. DASH client 208 may read the message, and this “message type” may represent the indication of the period boundary event.

In examples where messages are flowing bidirectionally between a WebSocket server (in this case, ROUTE handler 206) and a client (in this case, DASH client 208), the messages are no longer HTTP messages, and as such, do not contain a Content type header. In such cases, a Content type/MIME type cannot be used to distinguish between media data and an in-band message representing an indication of a period boundary/new IS. Nevertheless, every WebSocket frame is marked as either binary data or text data, e.g., by a single bit. Typically, ROUTE handler 206 marks media segments as including binary data using the single bit. Thus, to send the message indicating a new period boundary/new IS, ROUTE handler 206 may send a message marked as text data using the single bit, and then send the control cue message using this text mode. Hence, DASH client 208 may be configured to determine whether a received WebSocket frame is marked as including text, using the single bit, which may serve as an indication of the period boundary event, and hence, that a new IS is incoming.

Accordingly, DASH client 208 may check WebSocket frames for binary or text, per the following pseudocode:

if (msg.data instanceof ArrayBuffer)

{this is a binary data}

else

{this is a text data}

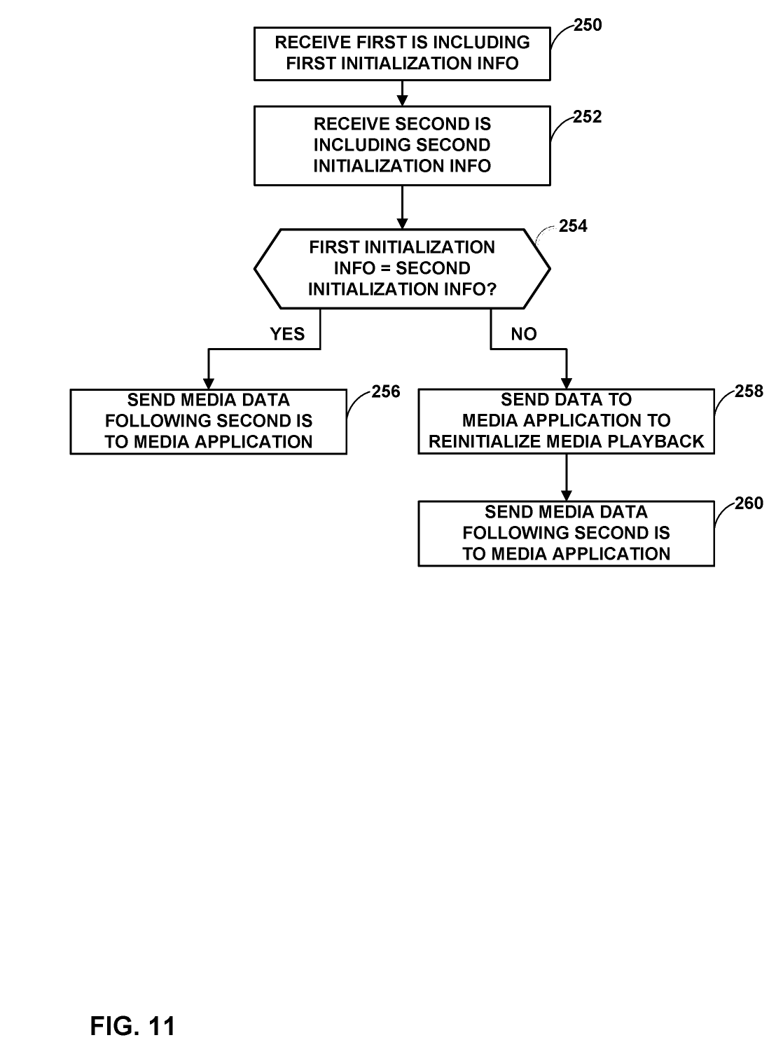

FIG. 11 is a flowchart illustrating an example method of receiving media data according to the techniques of this disclosure. The method of FIG. 11 may be performed by, for example, retrieval unit 52 of FIGS. 1 and 2. More particularly, the method of FIG. 11 may be performed by OTA middleware unit 100 of FIG. 2. Other components of this disclosure may also perform the method of FIG. 11, such as, for example, ROUTE handler 206 of FIGS. 5 and 10 or HTTP/WS proxy server 214 of FIG. 5. For purposes of explanation, the method of FIG. 11 is explained with respect to OTA middleware unit 100.

In the example of FIG. 11, initially, OTA middleware unit 100 receives a first initialization segment (IS) including first initialization information (250). As explained above, the first initialization information generally includes information usable by DASH client 110, media application 112, or a CODEC such as audio decoder 46 or video decoder 48 for accessing media data of subsequent segments. Although not shown in FIG. 1, it should be understood that OTA middleware unit 100 may receive one or more segments (e.g., containing media data, such as audio and/or video data) that are accessible using the first initialization information of the first IS.

After receiving the first IS (and one or more segments following the first IS), OTA middleware unit 100 may receive a second IS including second initialization information (252). In accordance with the techniques of this disclosure, OTA middleware unit 100 may determine whether the first initialization information is the same as the second initialization information (254). That is, OTA middleware unit 100 may determine whether the second initialization information of the second initialization segment is different than the first initialization information of the first initialization segment.

In some examples, to determine whether the second initialization information is different than or the same as (e.g., equal to) the first initialization information, OTA middleware unit 100 may determine whether a code point syntax element of the second initialization segment has a value indicating that the second initialization segment is a new initialization segment relative to the first initialization segment. For example, OTA middleware unit 100 may determine that the second initialization segment is new when the code point syntax element has a value equal to 2 or 3. In some examples, to determine whether the second initialization information is the same as or different than the first initialization information, OTA middleware unit 100 may determine whether a first checksum for the first initialization information is the same as or different than a second checksum for the second initialization information, and determine that the second initialization information is different when the second checksum is different than the first checksum.

In response to determining that the first initialization information is equal to the second initialization information (“YES” branch of 254), OTA middleware unit 100 may send media data (e.g., one or more segments) following the second initialization segment to media application 112 (256). That is, in this case, media application 112 need not reinitialize the media stream, because the second initialization information is the same as the first initialization information. Therefore, media application 112 may use the first initialization information when processing media data following the second initialization segment.

On the other hand, in response determining that the first initialization information is not equal to (i.e., different than) the second initialization information (“NO” branch of 254), OTA middleware unit 100 may send data to media application 112 to reinitialize media playback (258). For example, OTA middleware unit 100 may send an indication to media application 112 via a WebSocket connection to reinitialize media playback. In particular, OTA middleware unit 100 may establish the WebSocket connection with DASH client 110, which may provide data received via the WebSocket connection to media application 112. In some examples, OTA middleware unit 100 may initially close an existing WebSocket connection, and then reestablish the WebSocket connection prior to sending the indication. The data may include a textual indication to reinitialize media playback, such as the text representation “IS,” for “initialization segment.” The text representation may represent a control cue message indicating that the first initialization information of the first initialization segment is no longer valid. Moreover, OTA middleware unit 100 may send the second initialization information to media application 112 (e.g., via DASH client 110) to cause media application 112 to reinitialize using the second initialization information. Furthermore, OTA middleware unit 100 may then send media data following the second initialization segment to media application 112 (260).

In this manner, the method of FIG. 11 represents an example of a method including receiving a first initialization segment of a broadcast stream of media data, receiving a second initialization segment of the broadcast stream of media data, determining whether initialization information of the second initialization segment is different than initialization information of the first initialization segment, and in response to determining that the initialization information of the second initialization segment is different than the initialization information of the first initialization segment, sending an indication to a media application that media playback is to be reinitialized using the initialization information of the second initialization segment.

Likewise, the method of FIG. 11 also represents an example of a method including receiving a first initialization segment of a broadcast stream of media data, receiving a second initialization segment of the broadcast stream of media data, determining whether initialization information of the second initialization segment is different than initialization information of the first initialization segment, and in response to determining that the initialization information of the second initialization segment is the same as the initialization information of the first initialization segment, sending media data of the broadcast stream received following the second initialization segment to a media application without sending an indication to the media application that the media playback is to be reinitialized.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising, by a middleware unit of a client device:
receiving a first initialization segment of a broadcast stream of media data;
receiving a second initialization segment of the broadcast stream of media data;
determining whether initialization information of the second initialization segment is different than initialization information of the first initialization segment; and
in response to determining that the initialization information of the second initialization segment is different than the initialization information of the first initialization segment, sending an indication to a media application that media playback is to be reinitialized using the initialization information of the second initialization segment.

2. The method of claim 1, wherein determining whether the initialization information of the second initialization segment is different than the initialization information of the first initialization segment comprises determining whether a code point syntax element of the second initialization segment has a value indicating that the second initialization segment is a new initialization segment relative to the first initialization segment.

3. The method of claim 2, wherein determining whether the code point syntax element of the second initialization segment has the value indicating that the second initialization segment is the new initialization segment comprises determining that the second initialization segment is the new initialization segment when the value for the code point syntax element is equal to 2 or 3.

4. The method of claim 2, further comprising extracting the value for the code point syntax element from a layered coding transport (LCT) packet.

5. The method of claim 1, wherein determining whether the initialization information of the second initialization segment is different than the initialization information of the first initialization segment comprises determining that the initialization information of the second initialization segment is different than the initialization information of the first initialization segment when a first checksum for the initialization information of the first initialization segment is different than a second checksum for the initialization information of the second initialization segment.

6. The method of claim 1, wherein sending the indication comprises:
closing a WebSocket connection between the middleware unit and the media application; and
reestablishing the WebSocket connection between the middleware unit and the media application.

7. The method of claim 1, wherein sending the indication to the media application comprises sending the indication via a WebSocket connection between the middleware unit and the media application.

8. The method of claim 7, wherein sending the indication comprises sending a message via the WebSocket connection indicating that the first initialization segment is no longer valid.

9. The method of claim 8, wherein sending the message comprises:
sending message type information for the message indicating that the message includes text data; and
sending the message using a text representation of a control cue message indicating that the first initialization segment is no longer valid.

10. The method of claim 9, wherein the text representation comprises “IS.”

11. The method of claim 1, wherein sending the indication to the media application comprises sending the indication out-of-band relative to a WebSocket connection between the middleware unit and the media application.

12. The method of claim 11, further comprising signaling relative timing information between a channel by which the out-of-band indication is sent and the WebSocket connection.

13. The method of claim 1, further comprising, in response to determining that the initialization information of the second initialization segment is different than the initialization information of the first initialization segment, sending the initialization information of the second initialization segment to the media application.

14. The method of claim 1, further comprising, in response to the media application receiving the indication, reinitializing, by the media application, media playback using the initialization information of the second initialization segment.

15. A method of retrieving media data, the method comprising, by a middleware unit of a client device:
receiving a first initialization segment of a broadcast stream of media data;
receiving a second initialization segment of the broadcast stream of media data;
determining whether initialization information of the second initialization segment is different than initialization information of the first initialization segment; and
in response to determining that the initialization information of the second initialization segment is the same as the initialization information of the first initialization segment, sending media data of the broadcast stream received following the second initialization segment to a media application without sending an indication to the media application that the media playback is to be reinitialized.

16. The method of claim 15, wherein determining whether the initialization information of the second initialization segment is different than the initialization information of the first initialization segment comprises determining whether a code point syntax element of the second initialization segment has a value indicating that the second initialization segment is a new initialization segment relative to the first initialization segment.

17. The method of claim 16, wherein determining whether the code point syntax element of the second initialization segment has the value indicating that the second initialization segment is the new initialization segment comprises determining that the second initialization segment is the new initialization segment when the value for the code point syntax element is equal to 2 or 3.

18. The method of claim 16, further comprising extracting the value for the code point syntax element from a layered coding transport (LCT) packet.

19. The method of claim 15, wherein determining whether the initialization information of the second initialization segment is different than the initialization information of the first initialization segment comprises determining that the initialization information of the second initialization segment is different than the initialization information of the first initialization segment when a first checksum for the initialization information of the first initialization segment is different than a second checksum for the initialization information of the second initialization segment.

20. A device for retrieving media data, the device comprising:
a memory configured to store media data; and
a middleware unit comprising one or more processors implemented in circuitry and configured to:
receive a first initialization segment of a broadcast stream of media data;
receive a second initialization segment of the broadcast stream of media data;
determine whether initialization information of the second initialization segment is different than initialization information of the first initialization segment;
in response to determining that the initialization information of the second initialization segment is different than the initialization information of the first initialization segment, send an indication to a media application that media playback is to be reinitialized using the initialization information of the second initialization segment; and
in response to determining that the initialization information of the second initialization segment is the same as the initialization information of the first initialization segment, send media data of the broadcast stream received following the second initialization segment to the media application without sending the indication to the media application that the media playback is to be reinitialized.

21. The device of claim 20, wherein to determine whether the initialization information of the second initialization segment is different than the initialization information of the first initialization segment, the one or more processors are configured to determine whether a code point syntax element of the second initialization segment has a value indicating that the second initialization segment is a new initialization segment relative to the first initialization segment.

22. The device of claim 21, wherein the one or more processors are configured to determine that the second initialization segment is the new initialization segment when the value for the code point syntax element is equal to 2 or 3.

23. The device of claim 21, wherein the one or more processors are configured to extract the value for the code point syntax element from a layered coding transport (LCT) packet.

24. The device of claim 20, wherein the one or more processors are configured to determine that the initialization information of the second initialization segment is different than the initialization information of the first initialization segment when a first checksum for the initialization information of the first initialization segment is different than a second checksum for the initialization information of the second initialization segment.

25. The device of claim 20, wherein to send the indication, the one or more processors are configured to:
close a WebSocket connection between the middleware unit and the media application; and
reestablish the WebSocket connection between the middleware unit and the media application.

26. The device of claim 20, wherein to send the indication to the media application, the one or more processors are configured to send the indication via a WebSocket connection between the middleware unit and the media application.

27. The device of claim 26, wherein to send the indication, the one or more processors are configured to send a message via the WebSocket connection using a text representation of a control cue message indicating that the first initialization segment is no longer valid, the message including message type information for the message indicating that the message includes text data.

28. The device of claim 27, wherein the text representation comprises “IS.”

29. The device of claim 20, wherein the device comprises at least one of:
an integrated circuit;
a microprocessor; and
a wireless communication device.

30. A device for retrieving media data, the device comprising:
means for receiving a first initialization segment of a broadcast stream of media data;
means for receiving a second initialization segment of the broadcast stream of media data;
means for determining whether initialization information of the second initialization segment is different than initialization information of the first initialization segment;
means for sending, in response to determining that the initialization information of the second initialization segment is different than the initialization information of the first initialization segment, an indication to a media application that media playback is to be reinitialized using the initialization information of the second initialization segment; and
means for sending, in response to determining that the initialization information of the second initialization segment is the same as the initialization information of the first initialization segment, media data of the broadcast stream received following the second initialization segment to the media application without sending the indication to the media application that the media playback is to be reinitialized.
